(19) United States
(12) Patent Application Publication
(10) Pub. No.: US 2018/0136776 A1
(43) Pub. Date: May 17, 2018

(54) Method and Mobile Terminal for Identifying User Operation Mode

(71) Applicant: Huawei Technologies Co., Ltd., Shenzhen (CN)

(72) Inventor: Hui Xie, Shenzhen (CN)

(73) Assignee: Huawei Technologies Co., Ltd., Shenzhen (CN)

(21) Appl. No.: 15/575,250

(22) PCT Filed: May 19, 2015
(86) PCT No.: PCT/CN2015/079263

§ 371 Date: Nov. 17, 2017

(51) Int. Cl. G06F 3/041; H04M 1/725; G06F 3/044

(52) U.S. Cl. CPC G06F 3/0416; G06F 3/0488; G06F 3/044; H04M 1/72563

(57) ABSTRACT

A method for identifying a user operation mode, where when it is detected that a user touches a touch bar at a left side or a right side of a housing, a mobile terminal obtains a capacitance value of a detection channel of a touch point on the touch bar. The mobile terminal determines a quantity of effective channels in each touch point according to obtained capacitance values, where the effective channel is a detection channel whose capacitance value is greater than a first preset threshold. The mobile terminal collects statistics on a quantity of finger touch points and/or palm touch points according to the quantity of the effective channels in each touch point. The mobile terminal identifies whether a user operation mode is a left hand or right hand operation mode according to the quantity of the finger touch points and/or the palm touch points.

### CROSS REFERENCE TO RELATED APPLICATION

This application is a U.S. National Stage of International Patent Application No. PCT/CN2015/079263 filed on May 19, 2015, which is hereby incorporated by reference in its entirety.

### TECHNICAL FIELD

The present disclosure relates to the field of electronic technologies, and in particular, to a method and a mobile terminal for identifying a user operation mode.

### BACKGROUND

Currently, mobile terminals have become an integral part of people's lives, and users have increasingly high requirements on mobile terminals. Therefore, humanity and intelligence gradually become development trends of mobile phones, and mobile terminal manufacturers also gradually launch smartphones having higher configurations and larger screens. A smartphone having a large screen can give a user better visual experience, but a disadvantage is that it is inconvenient to operate using a single hand. To make it convenient for a user to operate a mobile terminal having a large screen using a single hand, many manufactures add single hand operation modes in user interfaces. Therefore, a left-handed display mode may be adjusted according to a user's habit of operating a mobile terminal using the left hand, and a right-handed display mode may be adjusted according to a user's habit of operating a mobile terminal using the right hand.

In an existing technical solution, an infrared sensor is disposed on left and right sides of a housing of a mobile terminal separately, when a user holds the mobile terminal using a hand and covers one of the infrared sensors, the infrared sensor transfers a detected signal to a mainboard, the mainboard determines, according to the received signal, whether the user operates the mobile terminal using the left hand or operates the mobile terminal using the right hand, and finally, the mainboard adjusts an interface display mode according to a determining result. However, this technical solution has the following disadvantages. Firstly, when the user operates the mobile terminal using a single hand, the two infrared sensors may be covered simultaneously, or none of the two infrared sensors may be covered at a same time, resulting in a high identification risk. Secondly, a location in which the infrared sensor is located needs to be produced to a transparent structural member, but the transparent structural member has high costs and is not attractive.

### SUMMARY

The present disclosure provides a method and a mobile terminal for identifying a user operation mode to improve accuracy of identifying a user operation mode.

A first aspect of the present disclosure provides a method for identifying a user operation mode, where a mobile terminal includes two touch bars, the two touch bars are separately disposed on left and right sides of a housing of the mobile terminal, each of the two touch bars includes multiple detection channels, and the method includes obtaining a capacitance value of a detection channel corresponding to a touch point on the touch bar when it is detected that a user touches the touch bar on the left or right side of the housing, where a touch area touched by a finger or a palm on the touch bar corresponds to a touch point, determining a quantity of effective channels in each touch point on the touch bar according to obtained capacitance values of detection channels corresponding to touch points on the touch bar, where the effective channel is a detection channel whose capacitance value is greater than a first preset threshold, collecting statistics on a quantity of finger touch points and/or palm touch points on the touch bar according to the quantity of the effective channels in each touch point on the touch bar, and identifying a user operation mode according to the quantity of the finger touch points and/or the palm touch points on the touch bar, where the user operation mode includes a left hand operation mode and a right hand operation mode.

With reference to the first aspect, in a first possible implementation manner of the first aspect, collecting statistics on a quantity of finger touch points and/or palm touch points on the touch bar according to the quantity of the effective channels in each touch point on the touch bar includes determining the quantity of the finger touch points and/or the palm touch points on the touch bar based on a preset condition and the quantity of the effective channels in each touch point on the touch bar.

With reference to the first possible implementation manner of the first aspect, in a second possible implementation manner of the first aspect, determining the quantity of the finger touch points and/or the palm touch points on the touch bar based on a preset condition and the quantity of the effective channels in each touch point on the touch bar includes determining the touch point as a palm touch point when a quantity of effective channels in a touch point on the touch bar is greater than a second preset threshold, or determining the touch point as a finger touch point when a quantity of effective channels in a touch point on the touch bar is not greater than the second preset threshold.

With reference to the first aspect, in a third possible implementation manner of the first aspect, collecting statistics on a quantity of finger touch points and/or palm touch points on the touch bar according to the quantity of the effective channels in each touch point on the touch bar includes obtaining an area of the effective channel, calculating an area of each touch point on the touch bar according to the quantity of the effective channels in each touch point on the touch bar and the area of the effective channel, and collecting statistics on the quantity of the finger touch points and/or the palm touch points on the touch bar according to the area of each touch point on the touch bar.

With reference to the third possible implementation manner of the first aspect, in a fourth possible implementation manner of the first aspect, collecting statistics on the quantity of the finger touch points and/or the palm touch points on the touch bar according to the area of each touch point on the touch bar includes determining the quantity of the finger touch points and/or the palm touch points on the touch bar based on a preset condition and the area of each touch point on the touch bar.

With reference to the fourth possible implementation manner of the first aspect, in a fifth possible implementation manner of the first aspect, determining the quantity of the finger touch points and/or the palm touch points on the touch bar based on a preset condition and the area of each touch point on the touch bar includes determining the touch point as a palm touch point if an area of a touch point on the touch bar is greater than a third preset threshold, or determining the touch point as a finger touch point if an area of each touch point on the touch bar is not greater than the third preset threshold.

With reference to any one of the first aspect and the first to fifth possible implementation manners of the first aspect, in a sixth possible implementation manner of the first aspect, identifying a user operation mode according to the quantity of the finger touch points and/or the palm touch points on the touch bar includes identifying that the user operation mode is the left hand operation mode when the quantity of the finger touch points on the touch bar on the right side of the housing of the mobile terminal is not less than three, identifying that the user operation mode is the left hand operation mode when the quantity of the palm touch points on the touch bar on the left side of the housing of the mobile terminal is one, and identifying that the user operation mode is the left hand operation mode when the quantity of the finger touch points on the touch bar on the right side of the housing of the mobile terminal is two and the quantity of the finger touch points on the touch bar on the left side of the housing of the mobile terminal is one.

With reference to any one of the first aspect and the first to fifth possible implementation manners of the first aspect, in a seventh possible implementation manner of the first aspect, identifying a user operation mode according to the quantity of the finger touch points and/or the palm touch points on the touch bar includes identifying that the user operation mode is the right hand operation mode when the quantity of the finger touch points on the touch bar on the left side of the housing of the mobile terminal is not less than three, identifying that the user operation mode is the right hand operation mode when the quantity of the palm touch points on the touch bar on the right side of the housing of the mobile terminal is one, and identifying that the user operation mode is the right hand operation mode when the quantity of the finger touch points on the touch bar on the left side of the housing of the mobile terminal is two and the quantity of the finger touch points on the touch bar on the right side of the housing of the mobile terminal is one.

With reference to any one of the first aspect and the first to seventh possible implementation manners of the first aspect, in an eighth possible implementation manner of the first aspect, identifying a user operation mode according to the quantity of the finger touch points and/or the palm touch points on the touch bar includes identifying that the user operation mode is a double hand operation mode when the quantity of the palm touch points on the touch bar on the right side of the housing of the mobile terminal is one and the quantity of the palm touch points on the touch bar on the left side of the housing of the mobile terminal is one.

With reference to the first aspect, in a ninth possible implementation manner of the first aspect, after identifying a user operation mode according to the quantity of the finger touch points and/or the palm touch points on the touch bar, the method further includes adjusting an interface display mode of the mobile terminal according to the user operation mode, where the interface display mode includes a left-handed display mode and a right-handed display mode.

With reference to the first aspect, in a tenth possible implementation manner of the first aspect, the touch bar includes multiple transverse electrodes and multiple longitudinal electrodes, where the multiple transverse electrodes and the multiple longitudinal electrodes are perpendicularly crossed to form multiple detection channels.

Correspondingly, a second aspect of the present disclosure provides a mobile terminal for identifying a user operation mode, where the mobile terminal includes two touch bars, the two touch bars are separately disposed on left and right sides of a housing of the mobile terminal, each of the two touch bars includes multiple detection channels, and the mobile terminal includes a value obtaining module configured to obtain a capacitance value of a detection channel corresponding to a touch point on the touch bar when it is detected that a user touches the touch bar on the left or right side of the housing, where a touch area touched by a finger or a palm on the touch bar corresponds to a touch point, a channel determining module configured to determine a quantity of effective channels in each touch point on the touch bar according to obtained capacitance values of detection channels corresponding to touch points on the touch bar, where the effective channel is a detection channel whose capacitance value is greater than a first preset threshold, a quantity statistics collection module configured to collect statistics on a quantity of finger touch points and/or palm touch points on the touch bar according to the quantity of the effective channels in each touch point on the touch bar, and a mode identifying module configured to identify a user operation mode according to the quantity of the finger touch points and/or the palm touch points on the touch bar, where the user operation mode includes a left hand operation mode and a right hand operation mode.

With reference to the second aspect, in a first possible implementation manner of the second aspect, the quantity statistics collection module is further configured to determine the quantity of the finger touch points and/or the palm touch points on the touch bar based on a preset condition and the quantity of the effective channels in each touch point on the touch bar.

With reference to the first possible implementation manner of the second aspect, in a second possible implementation manner of the second aspect, determining the quantity of the finger touch points and/or the palm touch points on the touch bar based on a preset condition and the quantity of the effective channels in each touch point on the touch bar includes determining the touch point as a palm touch point when a quantity of effective channels in a touch point on the touch bar is greater than a second preset threshold, or determining the touch point as a finger touch point when a quantity of effective channels in a touch point on the touch bar is not greater than the second preset threshold.

With reference to the second aspect, in a third possible implementation manner of the second aspect, the quantity statistics collection module further includes an area obtaining unit configured to obtain an area of the effective channel, an area calculation unit configured to calculate an area of each touch point on the touch bar according to the quantity of the effective channels in each touch point on the touch bar and the area of the effective channel, and a quantity determining unit configured to collect statistics on the quantity of the finger touch points and/or the palm touch points on the touch bar according to the area of each touch point on the touch bar.

With reference to the third possible implementation manner of the second aspect, in a fourth possible implementation manner of the second aspect, the quantity determining unit is further configured to determine the quantity of the finger touch points and/or the palm touch points on the touch bar based on a preset condition and the area of each touch point on the touch bar.

With reference to the fourth possible implementation manner of the second aspect, in a fifth possible implementation manner of the second aspect, the quantity determining unit is further configured to determine the touch point as a palm touch point if an area of a touch point on the touch bar is greater than a third preset threshold, or determine the touch point as a finger touch point if an area of each touch point on the touch bar is not greater than the third preset threshold.

With reference to any one of the second aspect and the first to fifth possible implementation manners of the second aspect, in a sixth possible implementation manner of the second aspect, the mode identifying module is further configured to identify that the user operation mode is the left hand operation mode when the quantity of the finger touch points on the touch bar on the right side of the housing of the mobile terminal is not less than three, identify that the user operation mode is the left hand operation mode when the quantity of the palm touch points on the touch bar on the left side of the housing of the mobile terminal is one, and identify that the user operation mode is the left hand operation mode when the quantity of the finger touch points on the touch bar on the right side of the housing of the mobile terminal is two and the quantity of the finger touch points on the touch bar on the left side of the housing of the mobile terminal is one.

With reference to any one of the second aspect and the first to fifth possible implementation manners of the second aspect, in a seventh possible implementation manner of the second aspect, the mode identifying module is further configured to identify that the user operation mode is the right hand operation mode when the quantity of the finger touch points on the touch bar on the left side of the housing of the mobile terminal is not less than three, identify that the user operation mode is the right hand operation mode when the quantity of the palm touch points on the touch bar on the right side of the housing of the mobile terminal is one, and identify that the user operation mode is the right hand operation mode when the quantity of the finger touch points on the touch bar on the left side of the housing of the mobile terminal is two and the quantity of the finger touch points on the touch bar on the right side of the housing of the mobile terminal is one.

With reference to any one of the second aspect and the first to fifth possible implementation manners of the second aspect, in an eighth possible implementation manner of the second aspect, the mode identifying module is further configured to identify that the user operation mode is a double hand operation mode when the quantity of the palm touch points on the touch bar on the right side of the housing of the mobile terminal is one and the quantity of the palm touch points on the touch bar on the left side of the housing of the mobile terminal is one.

With reference to the second aspect, in a ninth possible implementation manner of the second aspect, the mobile terminal further includes a mode adjustment module configured to adjust an interface display mode of the mobile terminal according to the user operation mode, where the interface display mode includes a left-handed display mode and a right-handed display mode.

With reference to the second aspect, in a tenth possible implementation manner of the second aspect, the touch bar includes multiple transverse electrodes and multiple longitudinal electrodes, where the multiple transverse electrodes and the multiple longitudinal electrodes are perpendicularly crossed to form multiple detection channels.

Correspondingly, a third aspect of the present disclosure provides a mobile terminal for identifying a user operation mode, where the mobile terminal includes two touch bars, where the two touch bars are separately disposed on left and right sides of a housing of the mobile terminal, and each of the two touch bars includes multiple detection channels, a display apparatus, a capacitance detection apparatus configured to obtain a capacitance value of a detection channel corresponding to a touch point on the touch bar when it is detected that a user touches the touch bar on the left or right side of the housing, where a touch area touched by a finger or a palm on the touch bar corresponds to a touch point, a memory, and a processor coupled to the memory, where a set of program code is stored in the memory, and the processor is configured to invoke the program code stored in the memory to perform the following operations of determining a quantity of effective channels in each touch point on the touch bar according to the capacitance value, obtained by the capacitance detecting unit, of the detection channel corresponding to the touch point on the touch bar, where the effective channel is a detection channel whose capacitance value is greater than a first preset threshold, collecting statistics on a quantity of finger touch points and/or palm touch points on the touch bar according to the quantity of the effective channels in each touch point on the touch bar, and identifying a user operation mode according to the quantity of the finger touch points and/or the palm touch points on the touch bar, where the user operation mode includes a left hand operation mode and a right hand operation mode.

With reference to the third aspect, in a first possible implementation manner of the third aspect, the processor further performs the following step of determining the quantity of the finger touch points and/or the palm touch points on the touch bar based on a preset condition and the quantity of the effective channels in each touch point on the touch bar.

With reference to the first possible implementation manner of the third aspect, in a second possible implementation manner of the third aspect, the processor further performs the following steps of determining the touch point as a palm touch point when a quantity of effective channels in a touch point on the touch bar is greater than a second preset threshold, or determining the touch point as a finger touch point when a quantity of effective channels in a touch point on the touch bar is not greater than the second preset threshold.

With reference to the third aspect, in a third possible implementation manner of the third aspect, the processor further performs the following steps of obtaining an area of the effective channel, calculating an area of each touch point on the touch bar according to the quantity of the effective channels in each touch point on the touch bar and the area of the effective channel, and collecting statistics on the quantity of the finger touch points and/or the palm touch points on the touch bar according to the area of each touch point on the touch bar.

With reference to the first possible implementation manner of the third aspect, in a fourth possible implementation manner of the third aspect, the processor further performs the following step of determining the quantity of the finger touch points and/or the palm touch points on the touch bar based on a preset condition and the quantity of the effective channels in each touch point on the touch bar.

With reference to the fourth possible implementation manner of the third aspect, in a fifth possible implementation manner of the third aspect, the processor further performs the following steps of determining the touch point as a palm touch point if an area of a touch point on the touch bar is greater than a third preset threshold, and determining the touch point as a finger touch point if an area of each touch point on the touch bar is not greater than the third preset threshold.

With reference to any one of the third aspect and the first to fifth possible implementation manners of the third aspect, in a sixth possible implementation manner of the third aspect, the processor further performs the following steps of identifying that the user operation mode is the left hand operation mode when the quantity of the finger touch points on the touch bar on the right side of the housing of the mobile terminal is not less than three, identifying that the user operation mode is the left hand operation mode when the quantity of the palm touch points on the touch bar on the left side of the housing of the mobile terminal is one, and identifying that the user operation mode is the left hand operation mode when the quantity of the finger touch points on the touch bar on the right side of the housing of the mobile terminal is two and the quantity of the finger touch points on the touch bar on the left side of the housing of the mobile terminal is one.

With reference to any one of the third aspect and the first to fifth possible implementation manners of the third aspect, in a seventh possible implementation manner of the third aspect, the processor further performs the following steps of identifying that the user operation mode is the right hand operation mode when the quantity of the finger touch points on the touch bar on the left side of the housing of the mobile terminal is not less than three, identifying that the user operation mode is the right hand operation mode when the quantity of the palm touch points on the touch bar on the right side of the housing of the mobile terminal is one, and identifying that the user operation mode is the right hand operation mode when the quantity of the finger touch points on the touch bar on the left side of the housing of the mobile terminal is two and the quantity of the finger touch points on the touch bar on the right side of the housing of the mobile terminal is one.

With reference to any one of the third aspect and the first to fifth possible implementation manners of the third aspect, in an eighth possible implementation manner of the third aspect, the processor further performs the following step of identifying that the user operation mode is a double hand operation mode when the quantity of the palm touch points on the touch bar on the right side of the housing of the mobile terminal is one and the quantity of the palm touch points on the touch bar on the left side of the housing of the mobile terminal is one.

With reference to the third aspect, in a ninth possible implementation manner of the third aspect, the processor further performs the following step of adjusting an interface display mode of the mobile terminal according to the user operation mode, where the interface display mode includes a left-handed display mode and a right-handed display mode.

With reference to the third aspect, in a tenth possible implementation manner of the third aspect, the touch bar includes multiple transverse electrodes and multiple longitudinal electrodes, where the multiple transverse electrodes and the multiple longitudinal electrodes are perpendicularly crossed to form multiple detection channels.

In implementation of the embodiments of the present disclosure, to resolve a technical problem that a risk of identifying a user operation mode is high, touch bars are separately disposed on left and right sides of a housing of a mobile terminal, and when the mobile terminal detects that a user touches the touch bar on the left or right side of the housing, firstly, the mobile terminal obtains a capacitance value of a detection channel of a touch point on the touch bar, and then determines a quantity of effective channels in each touch point on the touch bar, where the effective channel is a detection channel whose capacitance value is greater than a first preset threshold. Secondly, the mobile terminal collects statistics on a quantity of finger touch points and/or palm touch points on the touch bar according to the quantity of the effective channels in each touch point on the touch bar. Finally, the mobile terminal identifies a user operation mode according to the quantity of the finger touch points and/or the palm touch points on the touch bar, thereby improving accuracy of identifying the user operation mode and ensuring low costs without affecting the appearance.

### BRIEF DESCRIPTION OF DRAWINGS

To describe the technical solutions in the embodiments of the present disclosure more clearly, the following briefly describes the accompanying drawings required for describing the embodiments. The accompanying drawings in the following description show merely some embodiments of the present disclosure, and a person of ordinary skill in the art may still derive other drawings from these accompanying drawings without creative efforts.

FIG. 1 is a flowchart of a first embodiment of a method for identifying a user operation mode according to the present disclosure;

FIG. 2 is a schematic structural diagram of a mobile terminal according to an embodiment of the present disclosure;

FIG. 3 is a schematic structural diagram of another mobile terminal according to an embodiment of the present disclosure;

FIG. 4A and FIG. 4B are schematic diagrams of a change of a capacitance value of a detection channel in a touch bar according to an embodiment of the present disclosure;

FIG. 5 is a schematic diagram of a comparison between an area of a finger touch point and an area of a palm touch point in a touch bar according to an embodiment of the present disclosure;

FIG. 6 is a flowchart of a second embodiment of a method for identifying a user operation mode according to the present disclosure;

FIG. 7 is a schematic structural diagram of a mobile terminal for identifying a user operation mode according to an embodiment of the present disclosure;

FIG. 8 is a schematic structural diagram of a quantity statistics collection module in a mobile terminal according to an embodiment of the present disclosure; and

FIG. 9 is a schematic structural diagram of another mobile terminal for identifying a user operation mode according to an embodiment of the present disclosure.

### DESCRIPTION OF EMBODIMENTS

The following clearly describes the technical solutions in the embodiments of the present disclosure with reference to the accompanying drawings in the embodiments of the present disclosure. The described embodiments are merely some but not all of the embodiments of the present disclosure. All other embodiments obtained by a person of ordinary skill in the art based on the embodiments of the present disclosure without creative efforts shall fall within the protection scope of the present disclosure.

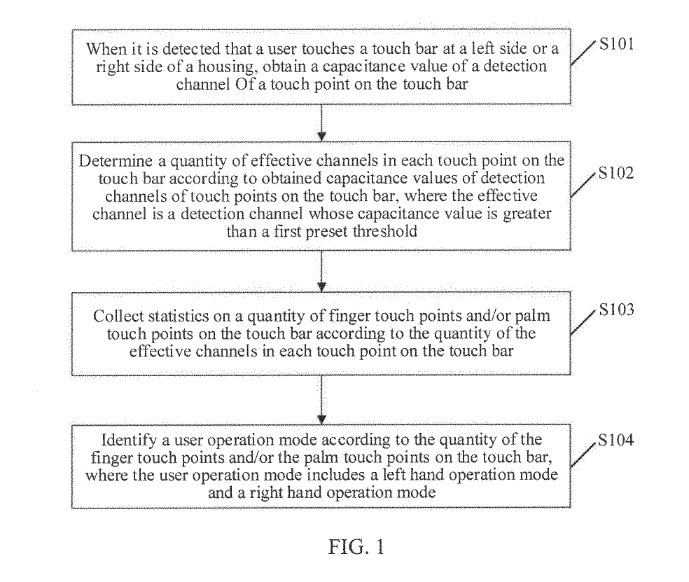

Referring to FIG. 1, FIG. 1 is a flowchart of a first embodiment of a method for identifying a user operation mode according to the present disclosure. The method in this embodiment of the present disclosure includes the following steps.

Step S101: When it is detected that a user touches a touch bar at a left side or a right side of a housing, obtain a capacitance value of a detection channel of a touch point on the touch bar.

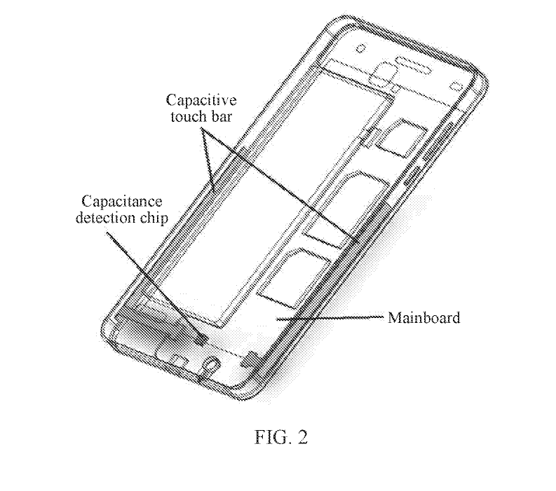

During specific implementation, as shown in FIG. 2, a mobile terminal may include two capacitive touch bars, a capacitance detection chip, and a processor (not shown in FIG. 2). The capacitance detection chip is located on a mainboard and is separately connected to the two touch bars and the processor, and the two touch bars are separately disposed on left and right sides of a housing of the mobile terminal. A working principle of the touch bar is similar to a touchpad on a notebook computer. Firstly, a principle diagram (multiple transverse electrodes and multiple longitudinal electrodes are perpendicularly crossed) may be designed according to a function requirement, and then the touch bar is produced according to the designed principle diagram using a flexible printed circuit (FPC). The touch bar may be stuck to a curved housing, and a double-sided tape is stuck on a front face of the FPC. During installation, the front face of the FPC is stuck to an inner side of the housing and is connected to the mainboard using a Board to Board (BTB) connector.

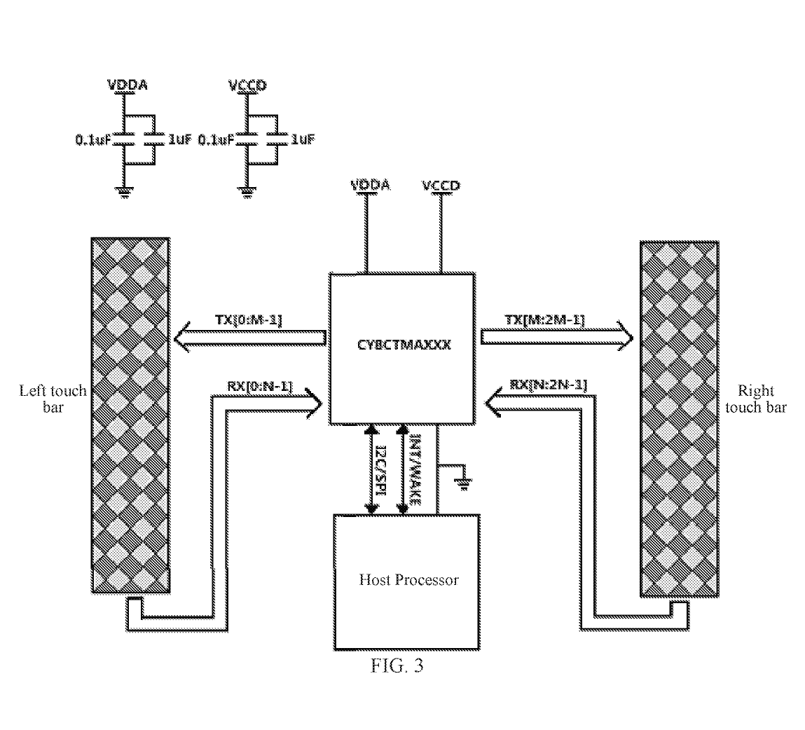

Further, as shown in FIG. 3, a mobile terminal may include a left touch bar, a right touch bar, a capacitance detection chip (designated as CY8CTMAXXX), and a processor. The left touch bar and the right touch bar are separately connected to the capacitance detection chip, and the capacitance detection chip is connected to the processor. The touch bar includes multiple transverse electrodes and multiple longitudinal electrodes. The multiple transverse electrodes and the multiple longitudinal electrodes are perpendicularly crossed to form multiple detection channels. A mutual capacitance is formed in a place in which the transverse electrode and the longitudinal electrode are perpendicularly crossed, and when the mobile terminal detects that a user touches a touch bar at a left side of a housing or a touch bar at a right side of a housing, coupling between a transverse electrode and a longitudinal electrode near a touch point is affected, thereby changing a capacitance value between the transverse electrode and the longitudinal electrode. During detection of a capacitance value of a mutual capacitance, firstly, the transverse electrodes send excitation signals in sequence, and at the same time, the longitudinal electrodes receive the signals such that capacitance values of cross points between the transverse electrodes and the longitudinal electrodes are obtained. Then, the capacitance detection chip obtains capacitance values of the detection channels on the touch bar. Finally, the capacitance detection chip outputs the capacitance values to the processor for processing. The longitudinal electrode is an electrode parallel to a lateral side of the touch bar, and the transverse electrode is an electrode perpendicular to the lateral side of the touch bar. The touch bar on the left side is located on a left side of the mobile terminal relative to the user and the touch bar on the right side is located on a right side of the mobile terminal relative to the user. A touch point is a touch location touched by a palm or a finger of the user on the touch bar.

Optionally, the capacitance detection chip may obtain a capacitance value of a detection channel on the touch bar on the left side, obtain a capacitance value of a detection channel on the touch bar on the right side, or obtain capacitance values of detection channels on the touch bars on the left and right sides. Further, the detection chip may obtain a capacitance value of a detection channel whose capacitance value is greater than zero on the touch bar, or obtain a capacitance value of each detection channel on the touch bar.

Step S102: Determine a quantity of effective channels in each touch point on the touch bar according to obtained capacitance values of detection channels of touch points on the touch bar, where the effective channel is a detection channel whose capacitance value is greater than a first preset threshold, and a finger or a palm corresponds to a touch point.

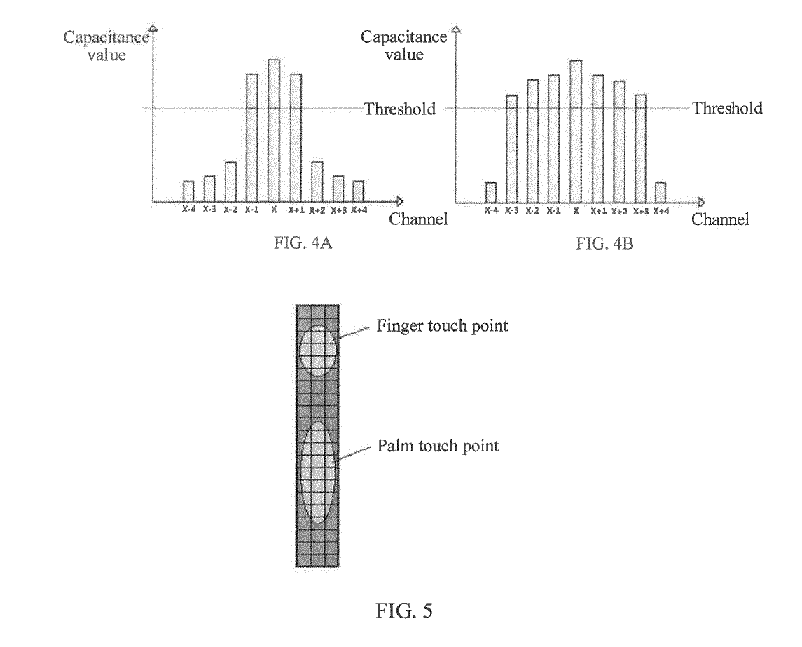

During specific implementation, when the mobile terminal detects that the user touches the touch bar on the left or right side of the housing, a change of the capacitance value of the detection channel may be obtained. A capacitance value of a detection channel at a centre of a touch point is a maximum capacitance value, and as distances from the centre of the touch point increase, capacitance values of the detection channels decrease in sequence. FIG. 4A shows capacitance values of detection channels in a finger touch point, and FIG. 4B shows capacitance values of detection channels in a palm touch point, where a centre of a touch point is a point whose horizontal coordinate is X, and the capacitance value of the detection channel corresponds to the point is a maximum capacitance value. When the capacitance value of the detection channel in each touch point is greater than the first preset threshold, the detection channel may be determined as an effective channel. As shown in FIG. 5, because an area of the palm touch point is greater than an area of the finger touch point, the quantity of the effective channels in the palm touch point is greater than the quantity of the effective channels in the finger touch point.

Step S103: Collect statistics on a quantity of finger touch points and/or palm touch points on the touch bar according to the quantity of the effective channels in each touch point on the touch bar.

During specific implementation, the quantity of the finger touch points and/or the palm touch points on the touch bar is determined based on a preset condition and the quantity of the effective channels in each touch point on the touch bar. Further, the touch point is determined as a palm touch point when a quantity of effective channels in a touch point on the touch bar is greater than a second preset threshold, or the touch point is determined as a finger touch point when a quantity of effective channels in a touch point on the touch bar is not greater than the second preset threshold. It should be noted that multiple finger touch points may exist simultaneously on one touch bar, but only one palm touch point exists on one touch bar and areas of effective channels on the touch bar are the same.

Optionally, an area of the effective channel may be obtained, an area of each touch point on the touch bar is calculated according to the quantity of the effective channels in each touch point on the touch bar and the area of the effective channel, and statistics on the quantity of the finger touch points and/or the palm touch points on the touch bar is collected according to the area of each touch point on the touch bar.

Further, the quantity of the finger touch points and/or the palm touch points on the touch bar may be determined based on a preset condition and the area of each touch point on the touch bar. Further, the touch point is determined as a palm touch point if an area of a touch point on the touch bar is greater than a third preset threshold, or the touch point is determined as a finger touch point if an area of each touch point on the touch bar is not greater than the third preset threshold.

Step S104: Identify a user operation mode according to the quantity of the finger touch points and/or the palm touch points on the touch bar, where the user operation mode includes a left hand operation mode and a right hand operation mode.

During specific implementation, the user operation mode is identified as the left hand operation mode when the quantity of the finger touch points on the touch bar on the right side of the housing of the mobile terminal is not less than three, the user operation mode is identified as the left hand operation mode when the quantity of the palm touch points on the touch bar on the left side of the housing of the mobile terminal is one, and the user operation mode is identified as the left hand operation mode when the quantity of the finger touch points on the touch bar on the right side of the housing of the mobile terminal is two and the quantity of the finger touch points on the touch bar on the left side of the housing of the mobile terminal is one, where the left hand operation mode is an operation mode in which the user holds the mobile terminal using the left hand.

Optionally, the user operation mode is identified as the right hand operation mode when the quantity of the finger touch points on the touch bar on the left side of the housing of the mobile terminal is not less than three, the user operation mode is identified as the right hand operation mode when the quantity of the palm touch points on the touch bar on the right side of the housing of the mobile terminal is one, and the user operation mode is identified as the right hand operation mode when the quantity of the finger touch points on the touch bar on the left side of the housing of the mobile terminal is two and the quantity of the finger touch points on the touch bar on the right side of the housing of the mobile terminal is one, where the right hand operation mode is an operation mode in which the user holds the mobile terminal using the right hand.

Optionally, when the quantity of the palm touch points on the touch bar on the right side of the housing of the mobile terminal is one and the quantity of the palm touch points on the touch bar on the left side of the housing of the mobile terminal is one, the user operation mode is identified as a double hand operation mode.

In this embodiment of the present disclosure, touch bars are separately disposed on left and right sides of a housing of a mobile terminal, and when the mobile terminal detects that a user touches the touch bar on the left or right side of the housing, firstly, the mobile terminal obtains a capacitance value of a detection channel on the touch bar, and then determines a quantity of effective channels in each touch point on the touch bar, where the effective channel is a detection channel whose capacitance value is greater than a first preset threshold. Secondly, the mobile terminal collects statistics on a quantity of finger touch points and/or palm touch points on the touch bar according to the quantity of the effective channels in each touch point on the touch bar. Finally, the mobile terminal identifies a user operation mode according to the quantity of the finger touch points and/or the palm touch points on the touch bar, thereby improving accuracy of identifying the user operation mode and ensuring low costs without affecting the appearance.

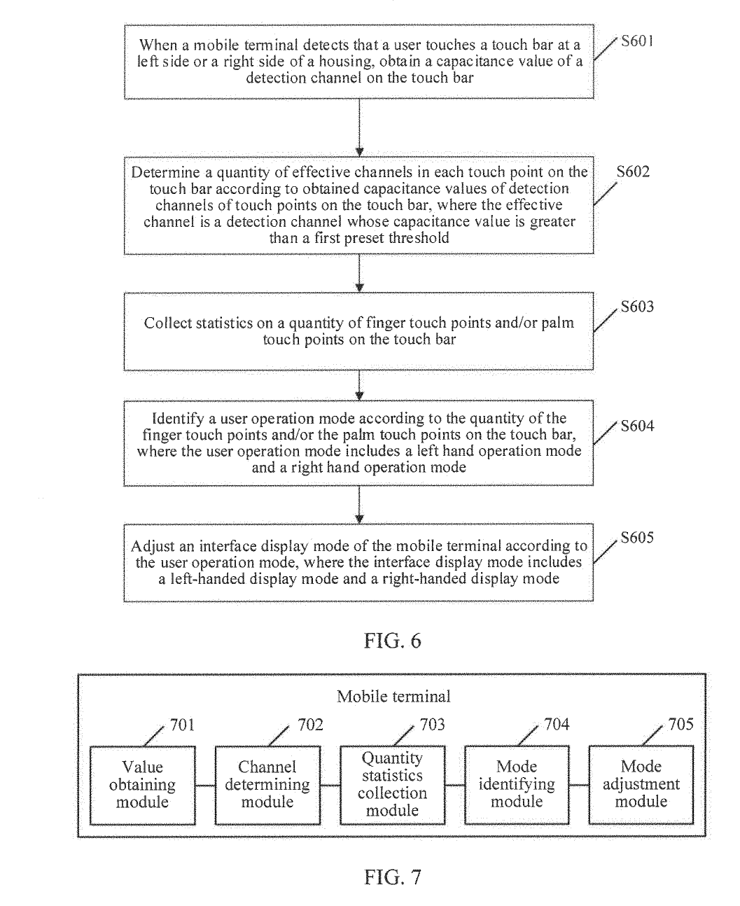

Referring to FIG. 6, FIG. 6 is a flowchart of a second embodiment of a method for identifying a user operation mode according to the present disclosure. The method in this embodiment of the present disclosure includes the following steps.

Step S601: When a mobile terminal detects that a user touches a touch bar at a left side or a right side of a housing, obtain a capacitance value of a detection channel on the touch bar.

During specific implementation, as shown in FIG. 2, a mobile terminal may include two touch bars, a capacitance detection chip, and a processor (not shown in FIG. 2). The capacitance detection chip is located on a mainboard and is separately connected to the two touch bars and the processor, and the two touch bars are separately disposed on left and right sides of the housing of the mobile terminal. A working principle of the touch bar is similar to a touchpad on a notebook computer. Firstly, a principle diagram may be designed according to a function requirement, and then the touch bar is produced according to the designed principle diagram using an FPC. The touch bar may be stuck to a curved housing, and a double-sided tape is stuck on a front face of the FPC. During installation, the front face of the FPC is stuck to an inner side of the housing and is connected to the mainboard using a BTB connector.

Further, as shown in FIG. 3, a mobile terminal may include a left touch bar, a right touch bar, a capacitance detection chip (designated as CY8CTMAXXX), and a processor. The left touch bar and the right touch bar are separately connected to the capacitance detection chip, and the capacitance detection chip is connected to the processor. The touch bar includes multiple transverse electrodes and multiple longitudinal electrodes, where the multiple transverse electrodes and the multiple longitudinal electrodes are perpendicularly crossed to form multiple detection channels. A mutual capacitance is formed in a place in which the transverse electrode and the longitudinal electrode are perpendicularly crossed, and when the mobile terminal detects that a user touches a touch bar at a left side of a housing or a touch bar at a right side of a housing, coupling between a transverse electrode and a longitudinal electrode near a touch point is affected, thereby changing a capacitance value between the transverse electrode and the longitudinal electrode. During detection of a capacitance value of a mutual capacitance, firstly, the transverse electrodes send excitation signals in sequence, and at the same time, the longitudinal electrodes receive the signals such that capacitance values of cross points between the transverse electrodes and the longitudinal electrodes are obtained. Then, the capacitance detection chip obtains capacitance values of the detection channels on the touch bar. Finally, the capacitance detection chip outputs the capacitance values to the processor for processing. The longitudinal electrode is an electrode parallel to a lateral side of the touch bar, and the transverse electrode is an electrode perpendicular to the lateral side of the touch bar. The touch bar on the left side is located on a left side of the mobile terminal relative to the user and the touch bar on the right side is located on a right side of the mobile terminal relative to the user. A touch point is a touch location touched by a palm or a finger of the user on the touch bar.

Optionally, the capacitance detection chip may obtain a capacitance value of a detection channel on the touch bar on the left side, obtain a capacitance value of a detection channel on the touch bar on the right side, or obtain capacitance values of detection channels on the touch bars on the left and right sides. Further, the detection chip may obtain a capacitance value of a detection channel whose capacitance value is greater than zero on the touch bar, or obtain a capacitance value of each detection channel on the touch bar.

Step S602: Determine a quantity of effective channels in each touch point on the touch bar according to the obtained capacitance value of the detection channel of a touch point on the touch bar, where the effective channel is a detection channel whose capacitance value is greater than a first preset threshold, and a finger or a palm corresponds to a touch point.

During specific implementation, when the mobile terminal detects that the user touches the touch bar on the left or right side of the housing, a change of the capacitance value of the detection channel may be obtained. A capacitance value of a detection channel at a centre of a touch point is a maximum capacitance value, and as distances from the centre of the touch point increase, capacitance values of the detection channels decrease in sequence. FIG. 4A shows capacitance values of detection channels in a finger touch point, and FIG. 4B shows capacitance values of detection channels in a palm touch point, where a centre of a touch point is a point whose horizontal coordinate is X, and the capacitance value of the detection channel corresponds to the point is a maximum capacitance value. When the capacitance value of the detection channel in each touch point is greater than the first preset threshold, the detection channel may be determined as an effective channel. As shown in FIG. 5, because an area of the palm touch point is greater than an area of the finger touch point, the quantity of the effective channels in the palm touch point is greater than the quantity of the effective channels in the finger touch point.

Step S603: Collect statistics on a quantity of finger touch points and/or palm touch points on the touch bar according to the quantity of the effective channels in each touch point on the touch bar.

During specific implementation, the quantity of the finger touch points and/or the palm touch points on the touch bar is determined based on a preset condition and the quantity of the effective channels in each touch point on the touch bar. Further, the touch point is determined as a palm touch point when a quantity of effective channels in a touch point on the touch bar is greater than a second preset threshold, or the touch point is determined as a finger touch point when a quantity of effective channels in a touch point on the touch bar is not greater than the second preset threshold. It should be noted that multiple finger touch points may exist simultaneously on one touch bar, but only one palm touch point exists on one touch bar and areas of effective channels on the touch bar are the same.

Optionally, an area of the effective channel may be obtained, an area of each touch point on the touch bar is calculated according to the quantity of the effective channels in each touch point on the touch bar and the area of the effective channel, and statistics on the quantity of the finger touch points and/or the palm touch points on the touch bar is collected according to the area of each touch point on the touch bar.

Further, the quantity of the finger touch points and/or the palm touch points on the touch bar may be determined based on a preset condition and the area of each touch point on the touch bar. Further, the touch point is determined as a palm touch point if an area of a touch point on the touch bar is greater than a third preset threshold, or the touch point is determined as a finger touch point if an area of each touch point on the touch bar is not greater than the third preset threshold.

Step S604: Identify a user operation mode according to the quantity of the finger touch points and/or the palm touch points on the touch bar, where the user operation mode includes a left hand operation mode and a right hand operation mode.

During specific implementation, the user operation mode is identified as the left hand operation mode when the quantity of the finger touch points on the touch bar on the right side of the housing of the mobile terminal is not less than three, the user operation mode is identified as the left hand operation mode when the quantity of the palm touch points on the touch bar on the left side of the housing of the mobile terminal is one, and the user operation mode is identified as the left hand operation mode when the quantity of the finger touch points on the touch bar on the right side of the housing of the mobile terminal is two and the quantity of the finger touch points on the touch bar on the left side of the housing of the mobile terminal is one, where the left hand operation mode is an operation mode in which the user holds the mobile terminal using the left hand.

Optionally, the user operation mode is identified as the right hand operation mode when the quantity of the finger touch points on the touch bar on the left side of the housing of the mobile terminal is not less than three, the user operation mode is identified as the right hand operation mode when the quantity of the palm touch points on the touch bar on the right side of the housing of the mobile terminal is one, and the user operation mode is identified as the right hand operation mode when the quantity of the finger touch points on the touch bar on the left side of the housing of the mobile terminal is two and the quantity of the finger touch points on the touch bar on the right side of the housing of the mobile terminal is one, where the right hand operation mode is an operation mode in which the user holds the mobile terminal using the right hand.

Optionally, the user operation mode is identified as a double hand operation mode when the quantity of the palm touch points on the touch bar on the right side of the housing of the mobile terminal is one and the quantity of the palm touch points on the touch bar on the left side of the housing of the mobile terminal is one.

Step S605: Adjust an interface display mode of the mobile terminal according to the user operation mode, where the interface display mode includes a left-handed display mode and a right-handed display mode.

During specific implementation, the interface display mode of the mobile terminal is adjusted to the right-handed display mode when the user operation mode is the right hand operation mode, and the interface display mode of the mobile terminal is adjusted to the left-handed display mode when the user operation mode is the left hand operation mode such that it is convenient for the user to operate using a single hand. The left-handed display mode is an interface display mode in which it is convenient for the user to operate using the left hand, and the right-handed display mode is an interface display mode in which it is convenient for the user to operate using the right hand.

In this embodiment of the present disclosure, touch bars are separately disposed on left and right sides of a housing of a mobile terminal, and when the mobile terminal detects that a user touches the touch bar on the left or right side of the housing, firstly, the mobile terminal obtains a capacitance value of a detection channel on the touch bar, and then determines a quantity of effective channels in each touch point on the touch bar, where the effective channel is a detection channel whose capacitance value is greater than a first preset threshold. Secondly, the mobile terminal collects statistics on a quantity of finger touch points and/or palm touch points on the touch bar according to the quantity of the effective channels in each touch point on the touch bar. Finally, the mobile terminal identifies a user operation mode according to the quantity of the finger touch points and/or the palm touch points on the touch bar, where the user operation mode includes a left hand operation mode and a right hand operation mode, thereby improving accuracy of identifying the user operation mode and ensuring low costs without affecting the appearance.

Referring to FIG. 7, FIG. 7 is a schematic structural diagram of a mobile terminal for identifying a user operation mode according to an embodiment of the present disclosure. The mobile terminal in this embodiment of the present disclosure includes a value obtaining module 701 configured to obtain a capacitance value of a detection channel on the touch bar when the mobile terminal detects that a user touches a touch bar at a left side or a right side of a housing.

During specific implementation, as shown in FIG. 2, a mobile terminal may include two touch bars, a capacitance detection chip, and a processor (not shown in FIG. 2). The capacitance detection chip is located on a mainboard and is separately connected to the two touch bars and the processor, and the two touch bars are separately disposed on left and right sides of the housing of the mobile terminal. A working principle of the touch bar is similar to a touchpad on a notebook computer. Firstly, a principle diagram may be designed according to a function requirement, and then the touch bar is produced according to the designed principle diagram using an FPC. The touch bar may be stuck to a curved housing, and a double-sided tape is stuck on a front face of the FPC. During installation, the front face of the FPC is stuck to an inner side of the housing and is connected to the mainboard using a BTB connector.

Further, as shown in FIG. 3, a mobile terminal may include a left touch bar, a right touch bar, a capacitance detection chip (designated as CY8CTMAXXX), and a processor. The left touch bar and the right touch bar are separately connected to the capacitance detection chip, and the capacitance detection chip is connected to the processor. The touch bar includes multiple transverse electrodes and multiple longitudinal electrodes, where the multiple transverse electrodes and the multiple longitudinal electrodes are perpendicularly crossed to form multiple detection channels. A mutual capacitance is formed in a place in which the transverse electrode and the longitudinal electrode are perpendicularly crossed, and when the mobile terminal detects that a user touches a touch bar at a left side of a housing or a touch bar at a right side of a housing, coupling between a transverse electrode and a longitudinal electrode near a touch point is affected, thereby changing a capacitance value between the transverse electrode and the longitudinal electrode. During detection of a capacitance value of a mutual capacitance, firstly, the transverse electrodes send excitation signals in sequence, and at the same time, the longitudinal electrodes receive the signals such that capacitance values of cross points between the transverse electrodes and the longitudinal electrodes are obtained. Then, the capacitance detection chip obtains capacitance values of the detection channels on the touch bar. Finally, the capacitance detection chip outputs the capacitance values to the processor for processing. The longitudinal electrode is an electrode parallel to a lateral side of the touch bar, and the transverse electrode is an electrode perpendicular to the lateral side of the touch bar. The touch bar on the left side is located on a left side of the mobile terminal relative to the user, and the touch bar on the right side is located on a right side of the mobile terminal relative to the user. A touch point is a touch location touched by a palm or a finger of the user on the touch bar.

Optionally, the capacitance detection chip may obtain a capacitance value of a detection channel on the touch bar on the left side, or obtain a capacitance value of a detection channel on the touch bar on the right side, or obtain capacitance values of detection channels on the touch bars on the left and right sides. Further, the detection chip may obtain a capacitance value of a detection channel whose capacitance value is greater than zero on the touch bar, or obtain a capacitance value of each detection channel on the touch bar. a channel determining module 702 configured to determine a quantity of effective channels in each touch point on the touch bar according to obtained capacitance values of detection channels of touch points on the touch bar, where the effective channel is a detection channel whose capacitance value is greater than a first preset threshold, and a finger or a palm corresponds to a touch point.

During specific implementation, when the mobile terminal detects that the user touches the touch bar on the left or right side of the housing, a change of the capacitance value of the detection channel may be obtained. A capacitance value of a detection channel at a centre of a touch point is a maximum capacitance value, and as distances from the centre of the touch point increase, capacitance values of the detection channels decrease in sequence. FIG. 4A shows capacitance values of detection channels in a finger touch point, and FIG. 4B shows capacitance values of detection channels in a palm touch point, where a centre of a touch point is a point whose horizontal coordinate is X, and the capacitance value of the detection channel corresponds to the point is a maximum capacitance value. When the capacitance value of the detection channel in each touch point is greater than the first preset threshold, the detection channel may be determined as an effective channel. As shown in FIG. 5, because an area of the palm touch point is greater than an area of the finger touch point, the quantity of the effective channels in the palm touch point is greater than the quantity of the effective channels in the finger touch point. A quantity statistics collection module 703 configured to collect statistics on a quantity of finger touch points and/or palm touch points on the touch bar according to the quantity of the effective channels in each touch point on the touch bar.

During specific implementation, the quantity of the finger touch points and/or the palm touch points on the touch bar is determined based on a preset condition and the quantity of the effective channels in each touch point on the touch bar. Further, the touch point is determined as a palm touch point when a quantity of effective channels in a touch point on the touch bar is greater than a second preset threshold, or the touch point is determined as a finger touch point when a quantity of effective channels in a touch point on the touch bar is not greater than the second preset threshold. It should be noted that multiple finger touch points may exist simultaneously on one touch bar, but only one palm touch point exists on one touch bar and areas of effective channels on the touch bar are the same.

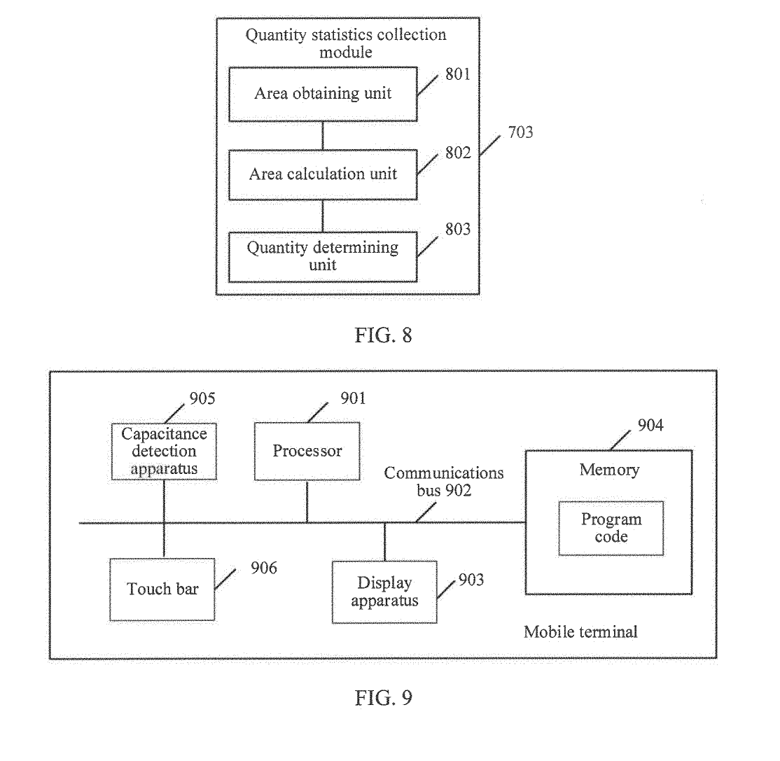

Optionally, as shown in FIG. 8, the quantity statistics collection module 703 may further include an area obtaining unit 801 configured to obtain an area of the effective channel, an area calculation unit 802 configured to calculate an area of each touch point on the touch bar according to the quantity of the effective channels in each touch point on the touch bar and the area of the effective channel, and a quantity determining unit 803 configured to collect statistics on the quantity of the finger touch points and/or the palm touch points on the touch bar according to the area of each touch point on the touch bar.

Further, the quantity of the finger touch points and/or the palm touch points on the touch bar may be determined based on a preset condition and the area of each touch point on the touch bar. Further, the touch point is determined as a palm touch point if an area of a touch point on the touch bar is greater than a third preset threshold, or the touch point is determined as a finger touch point if an area of each touch point on the touch bar is not greater than the third preset threshold. A mode identifying module 704 is configured to identify a user operation mode according to the quantity of the finger touch points and/or the palm touch points on the touch bar, where the user operation mode includes a left hand operation mode and a right hand operation mode.

During specific implementation, the user operation mode is identified as the left hand operation mode when the quantity of the finger touch points on the touch bar on the right side of the housing of the mobile terminal is not less than three, the user operation mode is identified as the left hand operation mode when the quantity of the palm touch points on the touch bar on the left side of the housing of the mobile terminal is one, and the user operation mode is identified as the left hand operation mode when the quantity of the finger touch points on the touch bar on the right side of the housing of the mobile terminal is two and the quantity of the finger touch points on the touch bar on the left side of the housing of the mobile terminal is one, where the left hand operation mode is an operation mode in which the user holds the mobile terminal using the left hand.

Optionally, the user operation mode is identified as the right hand operation mode when the quantity of the finger touch points on the touch bar on the left side of the housing of the mobile terminal is not less than three, the user operation mode is identified as the right hand operation mode when the quantity of the palm touch points on the touch bar on the right side of the housing of the mobile terminal is one, and the user operation mode is identified as the right hand operation mode when the quantity of the finger touch points on the touch bar on the left side of the housing of the mobile terminal is two and the quantity of the finger touch points on the touch bar on the right side of the housing of the mobile terminal is one, where the right hand operation mode is an operation mode in which the user holds the mobile terminal using the right hand.

Optionally, when the quantity of the palm touch points on the touch bar on the right side of the housing of the mobile terminal is one and the quantity of the palm touch points on the touch bar on the left side of the housing of the mobile terminal is one, the user operation mode is identified as a double hand operation mode.

Optionally, as shown in FIG. 7, the mobile terminal may further include a mode adjustment module 705 configured to adjust an interface display mode of the mobile terminal according to the user operation mode, where the interface display mode includes a left-handed display mode and a right-handed display mode.

During specific implementation, the interface display mode of the mobile terminal is adjusted to the right-handed display mode when the user operation mode is the right hand operation mode, and the interface display mode of the mobile terminal is adjusted to the left-handed display mode when the user operation mode is the left hand operation mode such that it is convenient for the user to operate using a single hand. The left-handed display mode is an interface display mode in which it is convenient for the user to operate using the left hand, and the right-handed display mode is an interface display mode in which it is convenient for the user to operate using the right hand.

In this embodiment of the present disclosure, touch bars are separately disposed on left and right sides of a housing of a mobile terminal, and when the mobile terminal detects that a user touches the touch bar on the left or right side of the housing, firstly, the mobile terminal obtains a capacitance value of a detection channel on the touch bar, and then determines a quantity of effective channels in each touch point on the touch bar, where the effective channel is a detection channel whose capacitance value is greater than a first preset threshold. Secondly, the mobile terminal collects statistics on a quantity of finger touch points and/or palm touch points on the touch bar according to the quantity of the effective channels in each touch point on the touch bar. Finally, the mobile terminal identifies a user operation mode according to the quantity of the finger touch points and/or the palm touch points on the touch bar, thereby improving accuracy of identifying the user operation mode and ensuring low costs without affecting the appearance.

Referring to FIG. 9, FIG. 9 is a schematic structural diagram of another mobile terminal for identifying a user operation mode according to an embodiment of the present disclosure. The mobile terminal includes two touch bars 906 (only one showed in FIG. 9), where the touch bars 906 are separately disposed on left and right sides of a housing of the mobile terminal, and each of the two touch bars 906 includes multiple detection channels. As shown in FIG. 9, the mobile terminal may further include a display apparatus 903, a memory 904, a capacitance detection apparatus 905, a processor 901 coupled to the memory 904, and a communications bus 902. The communications bus 902 is configured to implement communication between these components. The memory 904 may be a high-speed random access memory (RAM), or may further be a non-volatile memory, for example, at least one magnetic disk storage. Optionally, the memory 904 may further be at least one storage apparatus that is located far away from the processor 901.

The capacitance detection apparatus 905 is configured to obtain a capacitance value of a detection channel of a touch point on the touch bar 906 when it is detected that a user touches the touch bar 906 on the left or right side of the housing. The capacitance detection apparatus 905 may be a capacitance detection chip.

A program code is stored in the memory 904, and the processor 901 is configured to invoke the program code stored in the memory 904 to perform the following operations of determining a quantity of effective channels in each touch point on the touch bar 906 according to the capacitance value, obtained by the capacitance detecting apparatus 905, of the detection channel of the touch point on the touch bar 906, where the effective channel is a detection channel whose capacitance value is greater than a first preset threshold, and a finger or a palm corresponds to a touch point, collecting statistics on a quantity of finger touch points and/or palm touch points on the touch bar 906 according to the quantity of the effective channels in each touch point on the touch bar 906, and identifying a user operation mode according to the quantity of the finger touch points and/or the palm touch points on the touch bar 906, where the user operation mode includes a left hand operation mode and a right hand operation mode.

Optionally, the processor 901 further performs the following step of determining the quantity of the finger touch points and/or the palm touch points on the touch bar 906 based on a preset condition and the quantity of the effective channels in each touch point on the touch bar 906.

Optionally, the processor 901 further performs the following steps of determining the touch point as a palm touch point when a quantity of effective channels in a touch point on the touch bar 906 is greater than a second preset threshold, or determining the touch point as a finger touch point when a quantity of effective channels in a touch point on the touch bar 906 is not greater than the second preset threshold.

Optionally, the processor 901 further performs the following steps of obtaining an area of the effective channel, calculating an area of each touch point on the touch bar 906 according to the quantity of the effective channels in each touch point on the touch bar 906 and the area of the effective channel, and collecting statistics on the quantity of the finger touch points and/or the palm touch points on the touch bar 906 according to the area of each touch point on the touch bar 906.

Optionally, the processor 901 further performs the following step of determining the quantity of the finger touch points and/or the palm touch points on the touch bar 906 based on a preset condition and the area of each touch point on the touch bar 906.

Optionally, the processor 901 further performs the following steps of determining the touch point as a palm touch point if an area of a touch point on the touch bar 906 is greater than a third preset threshold, or determining the touch point as a finger touch point if an area of each touch point on the touch bar 906 is not greater than the third preset threshold.

Optionally, the processor 901 further performs the following steps of identifying that the user operation mode is the left hand operation mode when the quantity of the finger touch points on the touch bar 906 on the right side of the housing of the mobile terminal is not less than three, identifying that the user operation mode is the left hand operation mode when the quantity of the palm touch points on the touch bar 906 on the left side of the housing of the mobile terminal is one, and identifying that the user operation mode is the left hand operation mode when the quantity of the finger touch points on the touch bar 906 on the right side of the housing of the mobile terminal is two and the quantity of the finger touch points on the touch bar 906 on the left side of the housing of the mobile terminal is one.

Optionally, the processor 901 further performs the following steps of identifying that the user operation mode is the right hand operation mode when the quantity of the finger touch points on the touch bar 906 on the left side of the housing of the mobile terminal is not less than three, identifying that the user operation mode is the right hand operation mode when the quantity of the palm touch points on the touch bar 906 on the right side of the housing of the mobile terminal is one, and identifying that the user operation mode is the right hand operation mode when the quantity of the finger touch points on the touch bar 906 on the left side of the housing of the mobile terminal is two and the quantity of the finger touch points on the touch bar 906 on the right side of the housing of the mobile terminal is one.

Optionally, the processor 901 further performs the following step of identifying that the user operation mode is a double hand operation mode when the quantity of the palm touch points on the touch bar 906 on the right side of the housing of the mobile terminal is one and the quantity of the palm touch points on the touch bar 906 on the left side of the housing of the mobile terminal is one.

Optionally, the processor 901 further performs the following step of instructing, according to the user operation mode, the display apparatus 903 to adjust an interface display mode of the mobile terminal, where the interface display mode includes a left-handed display mode and a right-handed display mode.

It should be noted that, for brief description, the foregoing method embodiments are represented as a series of actions. However, a person skilled in the art should appreciate that the present disclosure is not limited to the described order of the actions, because according to the present disclosure, some steps may be performed in other orders or simultaneously. In addition, a person skilled in the art should also appreciate that all the embodiments described in the specification are example embodiments, and the related actions and modules are not necessarily mandatory to the present disclosure.

In the foregoing embodiments, the descriptions of the embodiments have respective focuses. For a part that is not described in detail in an embodiment, reference may be made to related descriptions in other embodiments.

A person of ordinary skill in the art may understand that all or a part of the steps of the methods in the embodiments may be implemented by a program instructing relevant hardware. The program may be stored in a computer readable storage medium. The storage medium may include a flash memory, a read-only memory (ROM), a RAM, a magnetic disk, an optical disc, or the like.

The foregoing describes in detail a method, and a mobile terminal for identifying a user operation mode that are provided by the embodiments of the present disclosure. In this specification, specific examples are used to describe the principle and implementation manners of the present disclosure, and the description of the embodiments is only intended to help understand the method and core idea of the present disclosure. Meanwhile, a person of ordinary skill in the art may, based on the idea of the present disclosure, make modifications with respect to the specific implementation manners and the application scope. Therefore, the content of this specification shall not be construed as a limitation to the present disclosure.

1.-33. (canceled)

34. A method for identifying a user operation mode, wherein a mobile terminal comprises two touch bars, wherein the two touch bars are separately disposed on a left side and a right side of a housing of the mobile terminal, wherein each of the two touch bars comprises a plurality of detection channels, and wherein the method comprises:
obtaining, by the mobile terminal, a capacitance value of each detection channel corresponding to each touch point on the two touch bars when the mobile terminal detects that a user touches at least one of the two touch bars, wherein a touch area touched by a finger or a palm on any one of the two touch bars corresponds to a touch point, and wherein the touch point corresponds to the plurality of detection channels;
obtaining, by the mobile terminal, a quantity of effective channels in each touch point on the two touch bars according to obtained capacitance values of detection channels corresponding to touch points on the two touch bars, wherein an effective channel comprises a detection channel whose capacitance value is greater than a first preset threshold;
collecting, by the mobile terminal, statistics on at least one of a quantity of finger touch points and a quantity of palm touch points on the two touch bars according to the quantity of the effective channels in each touch point on the two touch bars; and
identifying, by the mobile terminal, the user operation mode according to a collection result, wherein the user operation mode comprises one of a left hand operation mode, a right hand operation mode, and a double hand operation mode.

35. The method according to claim 34, wherein collecting statistics on the at least one of the quantity of the finger touch points and the quantity of the palm touch points on the two touch bars comprises obtaining, by the mobile terminal, at least one of the quantity of the finger touch points and the quantity of the palm touch points on the two touch bars based on a preset condition and the quantity of the effective channels in each touch point.

36. The method according to claim 35, wherein the preset condition comprises:
determining the touch point as a palm touch point when a quantity of effective channels in the touch point is greater than a second preset threshold; and
determining the touch point as a finger touch point when the quantity of effective channels in the touch point is not greater than the second preset threshold.

37. The method according to claim 34, wherein collecting statistics on the at least one of the quantity of the finger touch points and the quantity of the palm touch points on the two touch bars comprises:
obtaining, by the mobile terminal, an area of the effective channel;
calculating, by the mobile terminal, an area of each touch point according to the quantity of the effective channels in each touch point and the area of the effective channel; and
collecting, by the mobile terminal, statistics on the at least one of the quantity of the finger touch points and the quantity of the palm touch points on the two touch bars according to the area of each touch point.

38. The method according to claim 37, wherein collecting statistics on the at least one of the quantity of the finger touch points and the quantity of the palm touch points on the two touch bars according to the area of each touch point comprises obtaining at least one of the quantity of the finger touch points and the quantity of the palm touch points on the two touch bars based on a preset condition and the area of each touch point.

39. The method according to claim 38, wherein the preset condition comprises:
determining the touch point as a palm touch point when an area of the touch point is greater than a third preset threshold; and
determining the touch point as a finger touch point when the area of the touch point is not greater than the third preset threshold.

40. The method according to claim 34, wherein identifying the user operation mode comprises one of:
identifying that the user operation mode comprises the left hand operation mode when the quantity of the finger touch points on a touch bar on the right side of the housing is not less than three;
identifying that the user operation mode comprises the left hand operation mode when the quantity of the palm touch points on a touch bar on the left side of the housing is one; and
identifying that the user operation mode comprises the left hand operation mode when the quantity of the finger touch points on the touch bar on the right side of the housing is two and the quantity of the finger touch points on the touch bar on the left side of the housing is one.

41. The method according to claim 34, wherein identifying the user operation mode comprises one of:
identifying that the user operation mode comprises the right hand operation mode when the quantity of the finger touch points on a touch bar on the left side of the housing is not less than three;
identifying that the user operation mode comprises the right hand operation mode when the quantity of the palm touch points on a touch bar on the right side of the housing is one; and
identifying that the user operation mode comprises the right hand operation mode when the quantity of the finger touch points on the touch bar on the left side of the housing is two and the quantity of the finger touch points on the touch bar on the right side of the housing is one.

42. The method according to claim 34, wherein identifying the user operation mode comprises identifying that the user operation mode comprises the double hand operation mode when the quantity of the palm touch points on a touch bar on the right side of the housing is one and the quantity of the palm touch points on a touch bar on the left side of the housing is one.

43. The method according to claim 34, wherein after identifying the user operation mode, the method further comprises adjusting, by the mobile terminal, an interface display mode of the mobile terminal according to the user operation mode, and wherein the interface display mode comprises a left-handed display mode, a right-handed display mode and a double-handed display mode.

44. A mobile terminal for identifying a user operation mode, comprising:
two touch bars, wherein the two touch bars are separately disposed on a left side and a right side of a housing of the mobile terminal, and wherein each of the two touch bars comprises a plurality of detection channels;
a display coupled to the two touch bars;
a capacitance detector coupled to the two touch bars and the display and configured to obtain a capacitance value of each detection channel corresponding to each touch point on the two touch bars when the mobile terminal detects that a user touches at least one of the two touch bars, wherein a touch area touched by a finger or a palm on any one of the two touch bars corresponds to a touch point, and wherein the touch point corresponds to the plurality of detection channels;
a memory coupled to the two touch bars, the display, and the capacitance detector and configured to store a set of program code; and
a processor coupled to the two touch bars, the display, the capacitance detector, and the memory, wherein the set of program code causes the processor to be configured to:
obtain a quantity of effective channels in each touch point on the two touch bars according to capacitance values, obtained by the capacitance detector, of the detection channels corresponding to the touch point on the two touch bars, wherein an effective channel comprises a detection channel whose capacitance value is greater than a first preset threshold;
collect statistics on at least one of a quantity of finger touch points and a quantity of palm touch points on the two touch bars according to the quantity of the effective channels in each touch point on the two touch bars; and
identify the user operation mode according to a collection result, wherein the user operation mode comprises one of a left hand operation mode, a right hand operation mode, and a double hand operation mode.

45. The mobile terminal according to claim 44, wherein when collecting statistics on the at least one of the quantity of the finger touch points and the quantity of the palm touch points on the two touch bars, the set of program code further causes the processor to be configured to obtain at least one of the quantity of the finger touch points and the quantity of the palm touch points on the two touch bars based on a preset condition and the quantity of the effective channels in each touch point.

46. The mobile terminal according to claim 45, wherein the preset condition comprises:
determining the touch point as a palm touch point when a quantity of effective channels in the touch point is greater than a second preset threshold; and
determining the touch point as a finger touch point when the quantity of effective channels in the touch point is not greater than the second preset threshold.

47. The mobile terminal according to claim 44, wherein when collecting the statistics on the at least one of the quantity of the finger touch points and the quantity of the palm touch points on the two touch bars, the set of program code further causes the processor to be configured to:
obtain an area of the effective channel;
calculate an area of each touch point according to the quantity of the effective channels in each touch point and the area of the effective channel; and
collect statistics on the at least one of the quantity of the finger touch points and the quantity of the palm touch points on the two touch bars according to the area of each touch point.

48. The mobile terminal according to claim 47, wherein when collecting statistics on the at least one of the quantity of the finger touch points and the quantity of the palm touch points on the two touch bars according to the area of each touch point, the set of program code further causes the processor to be configured to obtain the at least one of the quantity of the finger touch points and the quantity of the palm touch points on the two touch bars based on a preset condition and the area of each touch point.

49. The mobile terminal according to claim 48, wherein the preset condition comprises:
determining the touch point as a palm touch point when an area of the touch point is greater than a third preset threshold; and
determining the touch point as a finger touch point when the area of the touch point is not greater than the third preset threshold.

50. The mobile terminal according to claim 44, wherein when identifying the user operation mode, the set of program code further causes the processor to be configured to perform one of:
identify that the user operation mode comprises the left hand operation mode when the quantity of the finger touch points on a touch bar on the right side of the housing is not less than three;
identify that the user operation mode comprises the left hand operation mode when the quantity of the palm touch points on a touch bar on the left side of the housing is one; and
identify that the user operation mode comprises the left hand operation mode when the quantity of the finger touch points on the touch bar on the right side of the housing is two and the quantity of the finger touch points on the touch bar on the left side of the housing is one.

51. The mobile terminal according to claim 44, wherein when identifying the user operation mode, the set of program code further causes the processor to be configured to perform one of:
identify that the user operation mode comprises the right hand operation mode when the quantity of the finger touch points on a touch bar on the left side of the housing is not less than three;
identify that the user operation mode comprises the right hand operation mode when the quantity of the palm touch points on a touch bar on the right side of the housing is one; and
identify that the user operation mode comprises the right hand operation mode when the quantity of the finger touch points on the touch bar on the left side of the housing is two and the quantity of the finger touch points on the touch bar on the right side of the housing is one.

52. The mobile terminal according to claim 44, wherein when identifying the user operation mode, the set of program code further causes the processor to be configured to identify that the user operation mode comprises the double hand operation mode when the quantity of the palm touch points on a touch bar on the right side of the housing is one and the quantity of the palm touch points on a touch bar on the left side of the housing is one.

53. The mobile terminal according to claim 44, wherein the set of program code further causes the processor to be configured to instruct, according to the user operation mode, the display to adjust an interface display mode of the mobile terminal, and wherein the interface display mode comprises a left-handed display mode, a right-handed display mode and a double-handed display mode.
